(19) United States
(12) Patent Application Publication
(10) Pub. No.: US 2014/0257680 A1
(43) Pub. Date: Sep. 11, 2014

(54) START-UP SUPPORT INCLUDING CLUTCH BITE POINT ADAPTION

(71) Applicants: Michael Pauli, Stuttgart (DE); Florian Pfeffer, Pliezhausen (DE); Wolf Bauer, Markgroeningen (DE)

(72) Inventors: Michael Pauli, Stuttgart (DE); Florian Pfeffer, Pliezhausen (DE); Wolf Bauer, Markgroeningen (DE)

(21) Appl. No.: 14/237,847

(22) PCT Filed: Jul. 19, 2012
(86) PCT No.: PCT/EP2012/064144

§ 371 Date: May 29, 2014

(30) Foreign Application Priority Data
Aug. 15, 2011 (DE) 102011080937.6

(51) Int. Cl. F02N 11/08

(52) U.S. Cl. CPC F02N 11/0803; F02N 2300/20
USPC 701/113

(57) ABSTRACT

A method for start-up support in a motor vehicle having a drive motor includes: detecting a possible start-up process; detecting a value for the clutch position; comparing the detected value with a predetermined first value range for the clutch position; and carrying out a start-up support if the detected value lies within the first value range.

### BACKGROUND OF THE INVENTION

1. Field of the Invention

The present invention relates to a method for start-up support in motor vehicles having mechanical manual transmissions. In particular, the present invention relates to methods which avoid an inadvertent activation of the start-up support.

2. Description of the Related Art

In conventional methods for start-up support, the start-up process is supported by providing an additional engine torque or increase in engine speed. This may cause inadvertent activations when switching on electrical loads or when engaging the power steering. This then leads to a speed overshoot which is perceptible both visually (tachometer) as well as acoustically.

### BRIEF SUMMARY OF THE INVENTION

The object of the present invention is to provide a method and a device for start-up support in which inadvertent activations are avoided.

A method for start-up support in a motor vehicle having a drive motor according to one specific embodiment of the present invention includes:
detecting a possible start-up process;
detecting a value for the clutch position;
comparing the detected value with a predetermined first value range for the clutch position; and
carrying out a start-up support if the detected value lies within the first value range.

Thus, with the method according to the present invention it is possible to recognize whether the clutch position is near the bite point. The start-up support may only be carried out specifically in situations in which the motor vehicle is actually started up. Inadvertent activations may be largely avoided.

A possible start-up process may be detected by ascertaining an engine torque, an engine speed, a position of the accelerator pedal and/or a speed of the vehicle. The start-up support may include an increase in speed and/or torque of the drive motor.

The method may further include:
detecting a plurality of start-up processes;
detecting the respective clutch position during each start-up process; and
ascertaining the first value range for the clutch position based on the detected values of the clutch position.

By ascertaining the first value range based on the detected values for the clutch position during previous start-up processes, it is possible to adapt the position and the width of the first value range, for example, to wear-related changes in the position of the clutch bite point. Thus, a reliable start-up support may be ensured even when the clutch is worn.

In this case, the first value range for the clutch position may be detected based on the mean value and the standard deviation of the detected clutch position during each start-up process.

A second value range for the clutch position may also be ascertained, the limits of which are extended beyond the limits of the first value range by a predetermined distance, and the start-up process being carried out if the detected value lies within the second value range. By introducing such a broader second value range, a start-up process may then also be carried out if due to extreme driving situations or due to other temporary fluctuations the clutch bite point changes relatively drastically in relation to the stored mean value.

In such a case, the distance between the limits of the second value range and the limits of the first value range may be increased if a start-up process is recognized in which the clutch position lies within the second value range, but not within the first value range, or if a start-up process is recognized in which the clutch position lies outside the second value range.

This makes it possible to adapt the limits within which the start-up support is carried out to the existence of temporary extreme driving situations (for example, start-up with a trailer, on slopes or the like). In the event a start-up support is not carried out during an actual start-up process because the limits of the second value range are too narrowly selected, it is possible by extending the limits of the second value range after such an error to ensure that a start-up support is provided at least in future start-up processes of this kind.

The detection of start-up processes is carried out in such cases based on the timing of the engine torque and/or engine speed. It is further conceivable to detect start-up processes based also on speed or acceleration data or based on the degree of actuation of the accelerator pedal.

In such a case, a maximum value for the width of the second value range may be predefined, which may not be exceeded even if the second value range is extended, i.e., when the distance between the limits of the second value range and the limits of the first value range is increased.

Alternatively, or in addition, the distance between the limits of the second value range and the limits of the first value range may be reduced if a start-up process is identified in which the clutch position lies within the first value range. Restricting the second value range in such a way makes it possible to avoid inadvertent activation of the start-up support in normal driving situations.

According to one further specific embodiment a minimum width of the second value range may be predefined.

The present invention furthermore provides a computer program product, which includes instructions which cause the method described above to be executed when loaded into a processor of a computer.

The present invention also provides a device for start-up support in a motor vehicle having a drive motor, including:
means for detecting a possible start-up process;
means for detecting a value for the clutch position;
means for comparing the detected value with a predetermined first value range for the clutch position, and
means for carrying out a start-up support if the detected value lies within the first value range.

Finally, the present invention provides a motor vehicle having a drive motor, a clutch assembly and the device described above.

### BRIEF DESCRIPTION OF THE DRAWINGS

FIG. 1 shows a schematic representation of a motor vehicle having a device according to one specific embodiment of the present invention.

FIG. 2 shows a flow chart of a method according to one specific embodiment of the present invention.

FIGS. 3a through c show three examples for carrying out the method shown in FIG. 2.

### DETAILED DESCRIPTION OF THE INVENTION

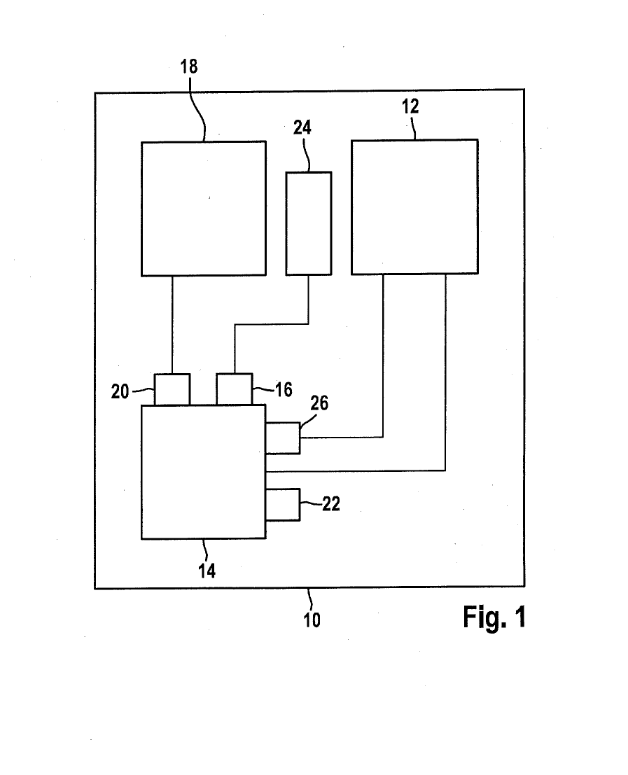

FIG. 1 schematically shows a motor vehicle 10 having a drive motor 12. A control unit 14 having a microprocessor is designed to output control signals for operating drive motor 12 and to receive signals from various sensors. An accelerator pedal 24 may be actuated by a driver of the motor vehicle.

An accelerator pedal sensor 16 is provided to detect a value for a position of accelerator pedal 24 and to output it to control unit 14. A speed sensor 26 is provided to detect a value for the speed of drive motor 12 and to output it to control unit 14.

Also provided is a clutch assembly 18, a clutch pedal path sensor 20 detecting an actuation of a clutch pedal (not shown), and outputting a value rClth for the clutch position to control unit 14.

A speed sensor 22 ascertains a value for the speed of the motor vehicle and outputs this to control unit 14.

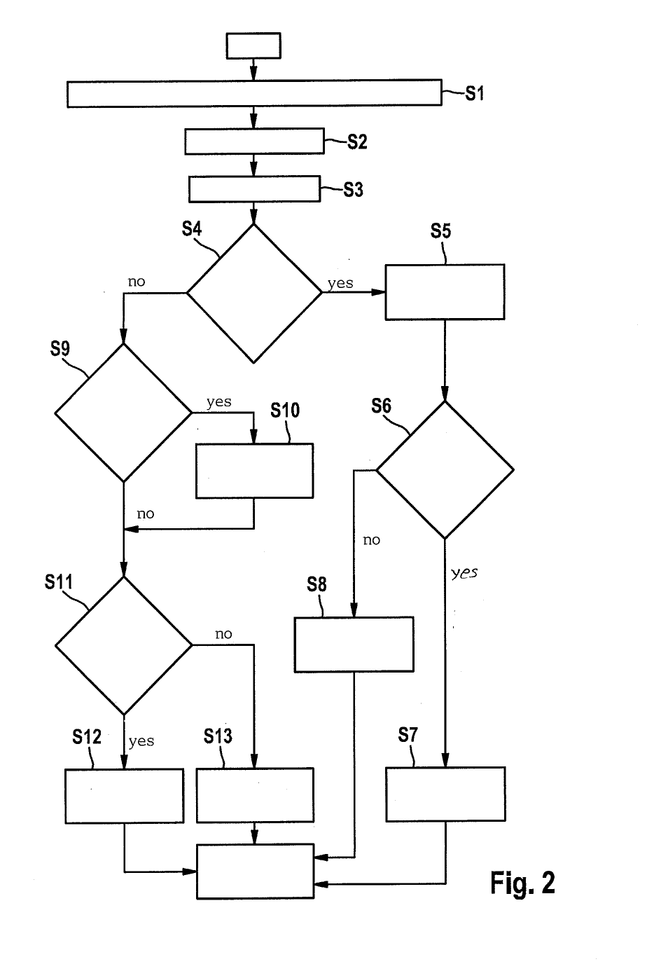

The operation of these components is explained below with reference to the method shown in FIG. 2.

In step S1, a possible start-up process is initially detected. Such a detection of possible start-up processes is known in principle and occurs in the present specific embodiment based on the detection of the timing of the engine torque and/or engine speed.

If a possible start-up process is detected, a clutch position rClth is subsequently ascertained in step S2 and the raw data for rClth are then smoothed by a low-pass filter (step S3).

In a previous calibration of the method according to the present invention a large number of clutch positions rClth were evaluated during detected start-up processes. Defined around the mean value of the clutch positions rClth during detected start-up processes is a first value range, the width of which may be defined, for example, by the standard deviation of the values for rClth during different start-up processes.

In the present specific embodiment of the present invention a second value range is also defined, the limits of which are selected to be wider than the limits of the first value range by a specific distance.

In step S4 it is checked whether the value for rClth during the instantaneously existing possible start-up process lies within the limits of the first value range. If this is the case (“yes” in step S4), a start-up support is then carried out in step S5, the engine speed or engine torque being increased in order to support the start-up process.

It is also conceivable that during start-up support the engine speed is not necessarily increased, but instead is initially only monitored by speed sensor 26, it being ensured that the engine speed does not drop below a minimum value during start-up, thereby preventing drive motor 12 from stalling.

In step S6 it is initially checked whether the distance of the band limits of the second value range relative to the band limits of the first value range is greater than a predefined minimum value. If this is the case (“yes” in step S6), then in step S7 the band limits of the second value range are narrowed by a predetermined amount, and thereby shifted closer to the band limits of the first value range. The method is then completed and is not called up again until the next detection of a possible start-up process.

If the distance of the band limits of the second value range relative to the band limits of the first value range is smaller than or equal to the predefined minimum value (“no” in step S6), then in step S8 the band limits of the second value range are adjusted in such a way that they have the minimum predefined distance relative to the band limits of the first value range. The method is then completed and is not called up again until the next detection of a possible start-up process.

If the ascertained value rClth for the clutch position during the possible start-up process does not lie within the limits of the first value range (“no” in step S4), then in step S9 it is checked whether rClth lies within the limits of the second value range. If this is the case (“yes” in step S9), a start-up support is carried out, the engine speed or engine torque being increased in order to support the start-up process or, as previously described, it is merely ensured that the engine speed does not drop below a minimum speed.

In step S11 it is subsequently checked whether the distance of the band limits of the second value range relative to the band limits of the first value range is smaller than a predefined maximum value. If this is the case (“yes” in step S11), then in step S12 the band limits of the second value range are extended by a predetermined amount and thereby shifted further away from the band limits of the first value range. The method is then completed and is not called up again until the next detection of a possible start-up process.

If the distance of the band limits of the second value range relative to the band limits of the first value range is greater than or equal to the predefined maximum value (“no” in step S11), then the band limits of the second value range are adjusted in step S13 in such a way that they have the maximum predefined distance relative to the band limits of the first value range. The method is then completed and is not called up again until the next detection of a possible start-up process.

If during the possible start-up process the ascertained value rClth for the clutch position does not lie within the limits of the second value range (“no” in step S9), then no start-up support is carried out, since it is assumed in this case that the clutch pedal has not approached the clutch bite point.

In steps S11 through S13 the limits of the second value range are subsequently extended as described above. The method is then completed and is not called up again until the next detection of a possible start-up process.

Thus, in the method described above, it may be detected whether during a start-up process the clutch pedal has approached the clutch bite point. It is only then that a start-up support is meaningful.

After each start-up process or at predefined intervals, the limits of the first value range may be adapted to the present mean values and standard deviations of rClth during detected start-up processes. Adapting the band limits of the first value range to the mean value of the detected clutch position during detected start-up processes ensures that even, for example, when the friction linings of the clutch are worn and the bite point has shifted, a reliable start-up support is still possible.

The wider selected limits of the second value range make it possible to carry out a start-up support even, for example, in cases of momentary fluctuations of rClth during start-up caused by wear or as a result of varying driving situations. The increment for narrowing and extending the limits may be adjusted.

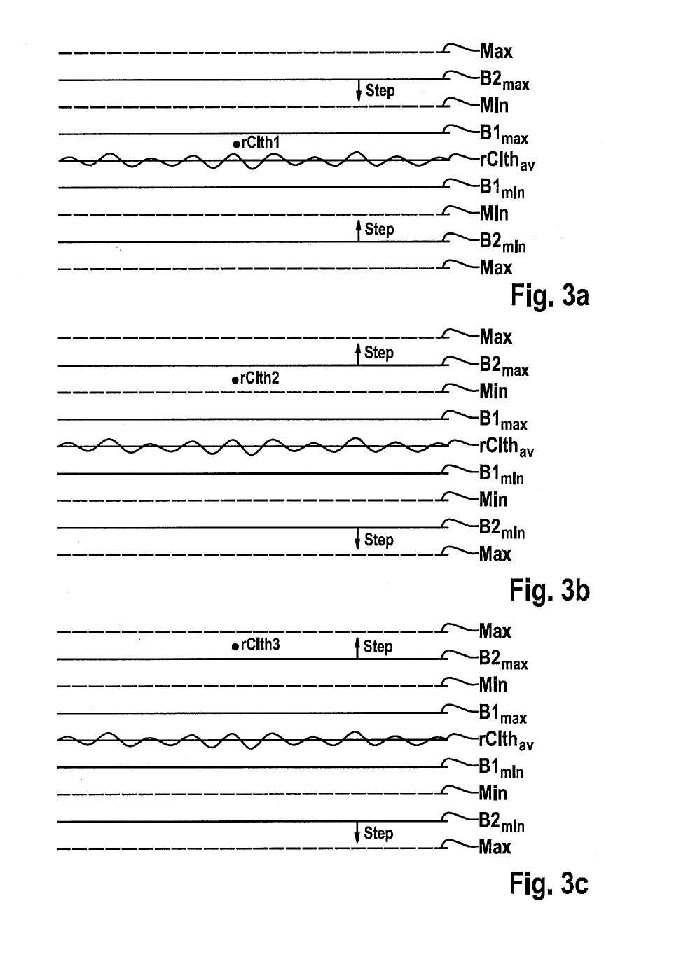

FIGS. 3a through c show three examples for carrying out the method according to the present invention.

Centered around the mean value rClth, of the rClth values for the clutch positions during detected start-up processes is the first value range having the band limits B1ₘᵢₙ and B1ₘₐₓ. The second value range having the band limits B2ₘᵢₙ and B2ₘₐₓ. encloses the first value range, band limits B2ₘᵢₙ and B2ₘₐₓ of the second value range being wider than band limits B1ₘᵢₙ and B1ₘₐₓ of the first value range.

In a first possible start-up process, shown in FIG. 3a, a clutch position rClth₁ is detected which lies within band limits B1ₘᵢₙ and B1ₘₐₓ of the first value range. This means that here in any case a clutch position is near the bite point and that a start-up support is carried out.

In addition, limits B2ₘᵢₙ and B2ₘₐₓ of the second value range are each narrowed by a predetermined incremental step. In this case, a predefined minimum value Min indicates the maximum possible narrowing of limits B2ₘᵢₙ and B2ₘₐₓ of the second value range.

In a second possible start-up process, shown in FIG. 3b, a clutch position rClth₂ is detected which lies outside of band limits B1ₘᵢₙ and B1ₘₐₓ of the first value range, but within band limits B2ₘᵢₙ and B2ₘₐₓ of the second value range. This means that in this case a clutch position is probably near the bite point and that a start-up support is carried out.

In addition, limits B2ₘᵢₙ and B2ₘₐₓ of the second value range are each extended by a predetermined incremental step. In this case, a predefined maximum value Max indicates the maximum possible expansion of limits B2ₘᵢₙ and B2ₘₐₓ of the second value range.

In a third possible start-up process, shown in FIG. 3c, a clutch position rClth₃ is detected which lies outside of band limits B1ₘᵢₙ and B1ₘₐₓ of the first value range and outside of band limits B2ₘᵢₙ and B2ₘₐₓ of the second value range. This means that in this case the clutch position is probably not near the bite point and that therefore, in order to avoid inadvertent activation of the start-up support, no start-up support is carried out.

Here too, limits B2ₘᵢₙ and B2ₘₐₓ of the second value range are each extended by a predetermined incremental step as long as they still lie within the bandwidth predefined by the maximum value Max.

1-10. (canceled)

11. A method for start-up support in a motor vehicle having a drive motor, comprising:
detecting a possible start-up process;
detecting a value for the clutch position;
comparing the detected value for the clutch position with a predetermined first value range for the clutch position; and
carrying out a start-up support if the detected value lies within the first value range;
wherein ascertainment of the first value range for the clutch position includes: (i) detecting a plurality of start-up processes; (ii) detecting a respective value for the clutch position during each start-up process; and (iii) ascertaining the first value range for the clutch position based on the detected respective values of the clutch position during the plurality of start-up process.

12. The method as recited in claim 11, wherein the first value range for the clutch position is ascertained based on the mean value and the standard deviation of the detected respective values of the clutch position during the plurality of start-up process.

13. The method as recited in claim 11, wherein:
a second value range for the clutch position is ascertained, the limits of the second value range extending beyond the limits of the first value range by a predetermined distance; and
the start-up process is carried out if the detected value lies within the second value range.

14. The method as recited in claim 13, wherein the distance between the limits of the second value range and the limits of the first value range is increased if one of: (i) a start-up process having a corresponding clutch position which lies within the second value range but not within the first value range is detected; or (ii) a start-up process having a corresponding clutch position which lies outside the second value range.

15. The method as recited in claim 13, wherein the distance between the limits of the second value range and the limits of the first value range is reduced if a start-up process having a corresponding clutch position which lies within the first value range.

16. The method as recited in claim 13, wherein a minimal width of the second value range is predefined.

17. A non-transitory computer-readable medium storing a computer program having program codes which, when executed on a computer, perform a method for start-up support in a motor vehicle having a drive motor, the method comprising:
detecting a possible start-up process;
detecting a value for the clutch position;
comparing the detected value for the clutch position with a predetermined first value range for the clutch position; and
carrying out a start-up support if the detected value lies within the first value range;
wherein ascertainment of the first value range for the clutch position includes: (i) detecting a plurality of start-up processes; (ii) detecting a respective value for the clutch position during each start-up process; and (iii) ascertaining the first value range for the clutch position based on the detected respective values of the clutch position during the plurality of start-up process.

18. A device for start-up support in a motor vehicle having a drive motor, comprising:
means for detecting a possible start-up process;
means for detecting a value for the clutch position;
means for comparing the detected value for the clutch position with a predetermined first value range for the clutch position;
means for carrying out a start-up support if the detected value lies within the first value range; and
means for ascertaining the first value range, wherein ascertainment of the first value range for the clutch position includes: (i) detecting a plurality of start-up processes; (ii) detecting a respective value for the clutch position during each start-up process; and (iii) ascertaining the first value range for the clutch position based on the detected respective values of the clutch position during the plurality of start-up process.
